(19) United States
(12) Patent Application Publication
(10) Pub. No.: US 2025/0261599 A1
(43) Pub. Date: Aug. 21, 2025

(54) IRRIGATION SYSTEM WITH AUTOMATIC TRANSITIONING ANCILLARY IRRIGATION SPAN

(71) Applicant: Reinke Manufacturing Company, Inc., Deshler, NE (US)

(72) Inventors: Brennan Joos ZIEGELMEIER, Colby, KS (US); Mark Randall Virus, Hebron, NE (US); Darin Joseph Neff, Hebron, NE (US); Russell Scott Reinke, Davenport, NE (US); Josiah John Carey, Deshler, NE (US); Monte Keith Stouffer, Fairmont, NE (US); Stony Darrel Yakovac, Lava Hot Springs, ID (US)

(21) Appl. No.: 19/058,544

(22) Filed: Feb. 20, 2025

Related U.S. Application Data
(60) Provisional application No. 63/555,771, filed on Feb. 20, 2024.

(51) Int. Cl. A01G 25/09; A01G 25/02; A01G 25/16

(52) U.S. Cl. CPC A01G 25/092; A01G 25/162; A01G 25/02

(57) ABSTRACT

An irrigation system and method are provided and include a primary irrigation system operative to rotate for irrigating an irrigation coverage area. An ancillary irrigation span is hingedly connected to a distal end of the primary irrigation system, the ancillary irrigation span being operative to automatically transition from a first configuration trailing movement of the distal end of the primary irrigation system to a second configuration leading movement of the distal end of the primary irrigation system to allow irrigation in areas outside a path of travel of the irrigation system, for example, corners of a crops field or to allow the irrigation system to irrigate near and around obstacles in the area of irrigation.

### CROSS-REFERENCE TO RELATED APPLICATIONS

The application entitled “Irrigation System with Automatic Transitioning Ancillary Irrigation Span,” claims the benefit of, and priority to, U.S. Provisional Application 63/555,771, filed Feb. 20, 2024, entitled “Irrigation System with Automatic Transitioning Ancillary Irrigation Span.” The entirety of the aforementioned application is incorporated by reference herein.

### TECHNICAL FIELD

The present disclosure generally relates to irrigation equipment and, more particularly, to center pivot irrigation systems which are provided with an ancillary irrigation span (i.e., swing arm) for irrigating corner areas and areas around obstacles of fields.

### BACKGROUND

The following discussion of the background of the disclosure is intended to facilitate an understanding of the present disclosure. However, it should be appreciated that the discussion acknowledgment or admission that any of the referenced material was published, known, or part of the common general knowledge as of the priority date of the application. Some embodiments of the disclosure are described herein with reference to irrigation equipment, machines and/or systems. However, it will be understood and appreciated by those having ordinary skill in the art that embodiments of the disclosure are not limited to irrigation system applications and may be used in other applications where optimizing liquid distribution within a bounded area would be beneficial.

A mechanized irrigation system enables producers and operators to manage water resources and, in some instances, other liquids. The primary purpose of these systems is to enable the application of an optimal amount of water at critical times during a crop's life cycle, fortifying crop health and maximizing yield potential. While many components make up a mechanized irrigation system, in general, such a system includes a mechanical structure, a drivetrain, and a control system managing water output.

One common type of mechanized irrigation system is a center pivot arrangement that includes a central pivot point about which the system rotates, swivels, or revolves. A span travels in a fixed circular operation about the central pivot point. The path of travel is determined by the span's radial position with respect to the central pivot point.

Although central-pivot-type irrigation systems function satisfactorily for the most part, they can water only circular areas. Most plots of land, however, are not circular, but are of some other shape, the most common of which is rectangular. A basic central pivot machine cannot irrigate the corner areas of rectangular fields or other areas outside the circle covered by the machine. Various attachments can attach to the span and cover a portion of the land area represented by field corners. One such attachment is a corner irrigation system incorporating an ancillary irrigation span, also known as a swing arm corner (SAC) span, which is added onto an outermost end of a primary center pivot system.

The SAC is placed at an angular orientation relative to the primary irrigation span. Some SACs have been able to move between a folded position where the SAC is folded back to an angular alignment no smaller than 90 degrees relative to the end of the primary irrigation span and an unfolded position where the SAC extends out at an angle to the primary irrigation span. Previous SACs were limited to extending out at an angle no smaller than 13 degrees relative to the end of the primary irrigation span when in the unfolded position. The SAC was capable of being in either a leading configuration, being out in front of, or trailing configuration, which is behind the primary (or parent) irrigation span. For example, a SAC configured to be leading always maintains a leading orientation or is out in front of the primary irrigation span throughout the entire path of travel, regardless of movement between the folded position and the unfolded position. A SAC configured to be trailing always maintains a trailing orientation or is behind the primary irrigation span throughout the entire path of travel, again regardless of movement between the folded position and the unfolded position.

In some cases, obstacles or the field shape may prevent the primary irrigation system from operating at 360 degrees of rotation. When full rotation is unachievable, systems can be designed to operate as a partial system or rotate less than 360 degrees. In most partial system cases, adding a SAC adds critical acres to the coverage area. However, the ancillary irrigation span hinge configuration prevents the parent system from traveling the maximum possible degrees since the SAC requires parking space at the start or stop angle. Thus, the desired irrigation coverage area of the field-of-interest not reached by the system when the SAC is parked in either a leading or trailing state at the start or stop angle does not receive desired irrigation.

There is a need in the art for an irrigation system with an ancillary irrigation span or swing arm corner span (SAC) that automatically transitions from a leading state to a trailing state during an irrigation run cycle for optimizing irrigation of a field-of-interest.

### SUMMARY

Aspects of one or more exemplary embodiments provide an improved irrigation system and method for using the improved irrigation system. An irrigation system may have an ancillary irrigation span or swing arm corner span (SAC) that automatically transitions from a leading state to a trailing state during an irrigation run cycle for optimizing irrigation of an irrigation coverage area of a field-of-interest. Additional aspects will be set forth in part in the description which follows and, in part, will become apparent from the description, or may be learned by practice of the exemplary embodiments.

According to one aspect, an irrigation machine and system are provided. The irrigation machine and system includes a primary irrigation span operative to rotate about a proximal end of the primary irrigation span for irrigating an irrigation coverage area. For example, the proximal end of the primary irrigation span may be rotatably coupled to a central pivot point about which the primary irrigation span rotates. An ancillary irrigation span is hingedly connected to a distal end of the primary irrigation span, the ancillary irrigation span being operative to automatically transition from a first configuration trailing movement of the distal end of the primary irrigation span to a second configuration leading movement of the distal end of the primary irrigation span.

The ancillary irrigation span is further operative to transition from an orientation in line with the primary irrigation span to the first configuration trailing movement of the distal end of the primary, the first configuration including rotating the ancillary irrigation span about the hinged connection to the trailing configuration such that the ancillary irrigation span is oriented up to a 90 degree angle behind the primary irrigation span. The ancillary irrigation span is still further operative to transition from an orientation in line with the primary irrigation span to the second configuration leading movement of the distal end of the primary irrigation span, the second configuration including rotating the ancillary irrigation span about the hinged connection to the leading configuration such that the ancillary irrigation span is oriented up to a 90 degree angle in front of the primary irrigation span. According to aspects, the ancillary irrigation span is operative to automatically transition to the first configuration away from a path of travel of the primary irrigation span to allow the irrigation machine to move to an obstacle in the irrigation coverage area and vice versa.

According to other aspects, when the irrigation machine or system encounters an obstacle in its path, the ancillary irrigation span is operative to automatically transition to the first configuration away from the path of travel of the primary irrigation span to irrigate a portion of the irrigation coverage area adjacent to the obstacle. The ancillary irrigation span is further operative to automatically transition to the second configuration ahead of a path of travel of the primary irrigation span to move the ancillary irrigation span around a portion of an obstacle in the irrigation coverage area to irrigate a portion of the irrigation coverage around the obstacle.

According to other aspects, a method of irrigating an irrigation coverage area is provided. The method includes receiving, by an irrigation system, an instruction to irrigate the irrigation coverage area, the irrigation system including a primary irrigation span operative to rotate about a proximal end of the primary irrigation span and an ancillary irrigation span hingedly connected to a distal end of the primary irrigation span, the ancillary irrigation span being operative to automatically transition from a first configuration trailing movement of the distal end of the primary irrigation span to a second configuration leading movement of the distal end of the primary irrigation span.

If a determination may be made that an obstacle is present in the irrigation coverage area that prevents a 360 degree rotation of the irrigation system along a path of travel around the irrigation coverage area, the irrigation system may be rotated along the path of travel while irrigating the irrigation coverage area. As the irrigation system approaches the obstacle, the ancillary irrigation span may be automatically transitioned to allow the irrigation system to approach the obstacle such that a portion of the irrigation coverage area adjacent to the obstacle receives irrigation. Automatically transitioning the ancillary irrigation span to allow the irrigation system to approach the obstacle may include transitioning the ancillary irrigation span to the first configuration to prevent the ancillary irrigation span from blocking access of the irrigation system to the portion of the irrigation coverage area adjacent to the obstacle. Automatically transitioning the ancillary irrigation span to allow the irrigation system to approach the obstacle may also include transitioning the ancillary irrigation span to the second configuration to allow the ancillary irrigation span to rotate around a portion of the obstacle to allow irrigation of a portion of the irrigation coverage area above the obstacle.

According to other aspects, based on one or more constraints associated with the irrigation coverage area requiring a given rate of travel of the irrigation system along the path of travel, a rate of travel of the irrigation system along the path of travel may be determined and applied. During rotation of the irrigation system along the path of travel while irrigating the irrigation coverage area, the rate of travel of the irrigation system along the path of travel may be adjusted based on determining that the one or more constraints associated with the irrigation coverage area requires one or more different rates of travel of the irrigation system along the path of travel. In addition to adjustment of the rate of travel of the irrigation system, the flow rate of fluid from the components of the irrigation system may be adjusted to ensure consistent fluid application over the field-of-interest or coverage area.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts a front elevation view of a section of an irrigation system, in accordance with aspects hereof;

FIG. 2 depicts a top plan view of the irrigation system of FIG. 1;

FIG. 3 is a schematic plan view of a center pivot irrigation system with an ancillary irrigation span operating in a corner of a field-of-interest or about an obstacle in accordance with an embodiment of the present disclosure;

FIG. 4 is a top plan view of an irrigated field-of-interest showing an irrigation obstacle and showing coverage of one or more irrigation coverage areas accordance with aspects hereof;

FIG. 5 depicts a flow diagram illustrating a method of irrigating an irrigation coverage area of a field-of-interest in accordance with aspects hereof; and

FIG. 6 is a simplified block diagram of a computing device with which examples of this disclosure may be practiced.

### DETAILED DESCRIPTION

Various modifications and different embodiments will be described below in detail with reference to the accompanying drawings so that those skilled in the art can carry out the disclosure. It should be understood, however, that the present disclosure is not intended to be limited to the specific embodiments, but the present disclosure includes modifications, equivalents or replacements that fall within the spirit and scope of the disclosure as defined in the following claims. The terminology used herein is for the purpose of describing specific embodiments only and is not intended to limit the scope of the disclosure.

As used herein, the singular forms “a”, “an” and “the” are intended to include the plural forms as well, unless the context clearly indicates otherwise. In the disclosure, terms such as “comprises”, “includes”, or “have/has” should be construed as designating that there are such features, integers, steps, operations, components, parts, and/or combinations thereof, not to exclude the presence or possibility of adding of one or more of other features, integers, steps, operations, components, parts, and/or combinations thereof.

In addition, aspects hereof may be described using relative location terminology. For example, the term “proximate” is intended to mean on, about, near, by, next to, at, and the like. The term “about” when used in relation to measurements means within +10% of a designated value. Therefore, when a feature is proximate another feature, it is close in proximity but not necessarily exactly at the described location or in abutting contact, in some aspects. Additionally, the term “distal” refers to a portion of a feature herein that is positioned away from a midpoint of the feature. Terms such as “coupled,” “attached,” “fastened,” “secured,” “affixed,” and the like may mean elements that are releasably attached or connected to one another using, for example, bolts and the like. These terms may further mean elements that are permanently attached to one another using, for example, rivets, welding, and the like.

The term “releasable fastener” as used herein refers to a fastener system that can be repeatedly, selectively, coupled and uncoupled to respectively secure or disengage components from each other. In line with this, the term “complementary” when describing components of a releasable fastener system means components having structures that mechanically engage with each other (e.g., a nut and a bolt may mechanically engage one another at threads formed thereon).

The term “end” when used in relation to the end of a pipeline, rail, or truss rod may mean a terminal edge of said component. Such term may also mean a portion of the pipeline, rail, or truss rod within about 12 inches of the terminal edge of said component. The term “about” when used in relation to measurements means within +10% of a designated value. The terms “axial direction” and “longitudinal direction” are used interchangeably herein and mean the direction the pipeline, rail, or truss rod extends from a first end of said component to a second end of said component. The term “substantially” when used in relation to positional descriptions means primarily.

At a high level, aspects herein are directed to an irrigation system having a primary irrigation span and an ancillary irrigation span (or swing arm corner span (SAC)) rotatably coupled to a distal end of the primary irrigation span. The ancillary irrigation span being configured such that it may automatically transition from a leading state to a trailing state, relative to the primary irrigation span, during operation.

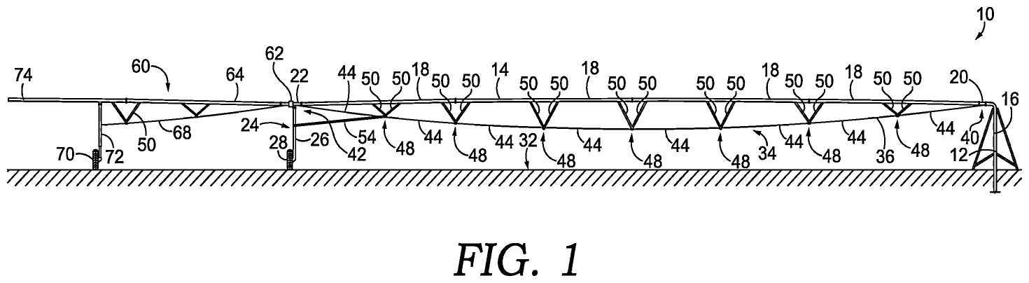

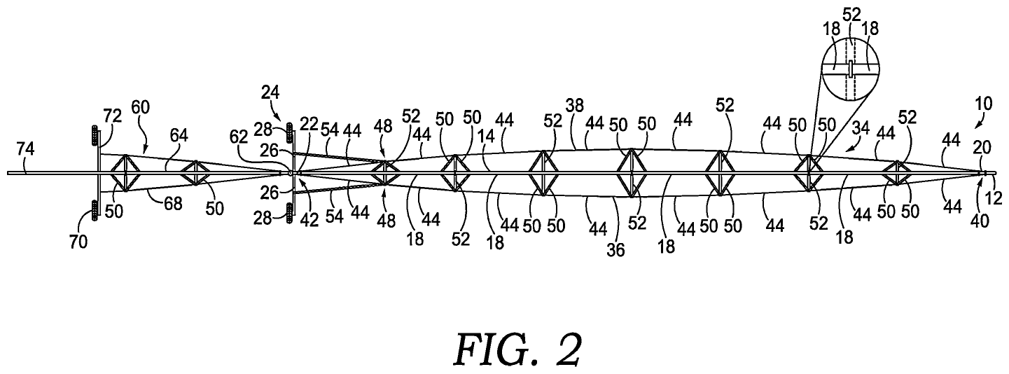

Referring now initially to FIGS. 1 and 2, an aspect of an irrigation system is illustrated. According to aspects, the irrigation system includes a primary irrigation system 10 and an ancillary irrigation span 60. The illustrated primary irrigation system 10 is a segment of a center-pivot type irrigation system that revolves or rotates around a fluid source 12. In other aspects, however, the irrigation system may be a linear or lateral move irrigation system, or any other type of irrigation system. The illustrated primary irrigation system 10 includes a pipeline 14 coupled to the fluid source 12. The pipeline 14 extends from the fluid source 12 to a tower 24. In other aspects, however, the primary irrigation system 10 may include a plurality of spans, each including a pipeline 14 and a tower 24. Regardless of the number spans the primary irrigation system 10 is composed of, the pipeline 14 may comprise a plurality of pipe segments 18 coupled to one another. In other words, each span of the primary irrigation system 10 may include multiple pipe segments joined together to communicate irrigation fluid therethrough.

A first segment 20 of the pipeline 14 may connect to the fluid source 12 with a span coupling. The first segment 20 may include the span coupling, or a portion of the span coupling (e.g., a hook), for detachably coupling to the fluid source 12. The span coupling may comprise a hook and receiver type span coupling. For example, the first segment 20 may include a hook that may be detachably coupled to a receiver (e.g., a ring) connected to the fluid source 12. Such a span coupling may provide a highly efficient point of rotation for the pipeline 14 when placed in the center of the pipeline 14.

It may be advantageous in some aspects to provide a multi-span irrigation system to permit irrigation of a greater area. For example, the irrigation system 10 may comprise a first span, a second span, and an ancillary irrigation span, or a swing arm that may be attached to the second span. Thus, the multi-span irrigation system may include a primary irrigation system 10 composed of two or more irrigation spans and an ancillary irrigation system 60 coupled to the last span of the two or more irrigation spans of the irrigation system 10. Continuing with this example, the second span may be coupled to the last segment 22 of the pipeline 14 of the first span of the primary irrigation system 10 to increase the area over which the combined irrigation system travels. Thus, the last segment 22 of the pipeline 14 may include a span coupling (e.g., a hook and a receiver), or a portion of a span coupling, (e.g., a receiver) for connecting to a span coupling (e.g., a hook) of the ancillary irrigation span, or swing arm. Hook-and-receiver type span couplings are preferred, but other types of span couplings may also be useful with the present invention.

The tower 24 supports the last segment 22 of the pipeline 14. In other aspects, the tower 24 may support an intermediate portion of the pipeline 14 resulting in a portion of the pipeline 14 cantilevered past the tower 24. The tower 24 includes one or more support legs 26 and one or more wheels 28. In some aspects, the tower 24 is self-propelled and includes a drive unit that causes the wheels to rotate to carry the pipeline 14 over a field-of-interest or irrigation coverage area such as a crops field. In other aspects, other equipment (e.g., electronics) may be mounted on the tower 24.

A truss system 34 includes a first truss rail 36 and a second truss rail 38 (FIG. 2). In some aspects, the truss system may include only one truss rail. In other aspects, the truss system may include more than two truss rails. The first truss rail 36 and the second truss rail 38 are substantially similar and the following description of the first truss rail 36 applies equally to the second truss rail. A first end 40 of the first truss rail 36 is coupled to the first segment 20 of the pipeline 14. Likewise, a second end 42 of the first truss rail 36 is coupled to the last segment 22 of the pipeline 14. The first truss rail 36 includes a plurality of headed truss rods 44 coupled end-to-end between a pair of cooperating mating members 46 at each of one or more intermediate joints 48.

The truss system 34 includes a plurality of pairs of struts 50 extending from the pipeline 14 with which they are coupled via conventional means (e.g., fastened to a plate that is welded to the pipeline 14). Each pair of struts 50 additionally is coupled to each other at one of the intermediate joints 48, as more fully described below. The truss system 34 further includes a plurality of cross-members 52 (FIG. 2). Each said cross-member 52 extends from one of the intermediate joints 48 of the first truss rail 36 to an intermediate joint of the second truss rail 38 and spaces the intermediate joints, and thereby the first and second truss rails 36, 38, apart. In the illustrated embodiment, a brace 54 also extends from the tower 24 to one of the intermediate joints 48 to provide additional support and to stabilize the tower 24. In some aspects, one or more of the intermediate joints may comprise flying joints that do not have a strut 50, a cross-member 52, or a brace 54 attached. Thus, these flying joints include only adjacent truss rods 44 coupled end-to-end between the pair of cooperating members 46.

Referring still to FIGS. 1 and 2, the ancillary irrigation span 60 (e.g., swing arm corner span (SAC)) is generally similar in construction to the spans of the primary irrigation system 10. The ancillary irrigation span 60 is connected to the primary pipeline at a hinge point 62 at which the ancillary irrigation span 60 is coupled with a distal end of the primary irrigation system 10. The ancillary irrigation span 60 includes a pipeline 64, struts 50, truss rods 68 and ancillary steering tower 72 (along with wheels 70) positioned along the length of the ancillary irrigation span 60 at a distance spaced from the hinge point 62. According to one aspect, an extension pipeline or boom 74 may be utilized for reaching into corners beyond the reach of the distal end of the pipeline 64. The ancillary steering tower 72 of the ancillary irrigation span 60 is controllable independently of the central pivot point and/or the primary irrigation system 10. In embodiments, the ancillary steering tower 72 includes one or more motors (not shown) and electronic components (not shown) suitable for controlling movement of the ancillary irrigation span 60, as described herein.

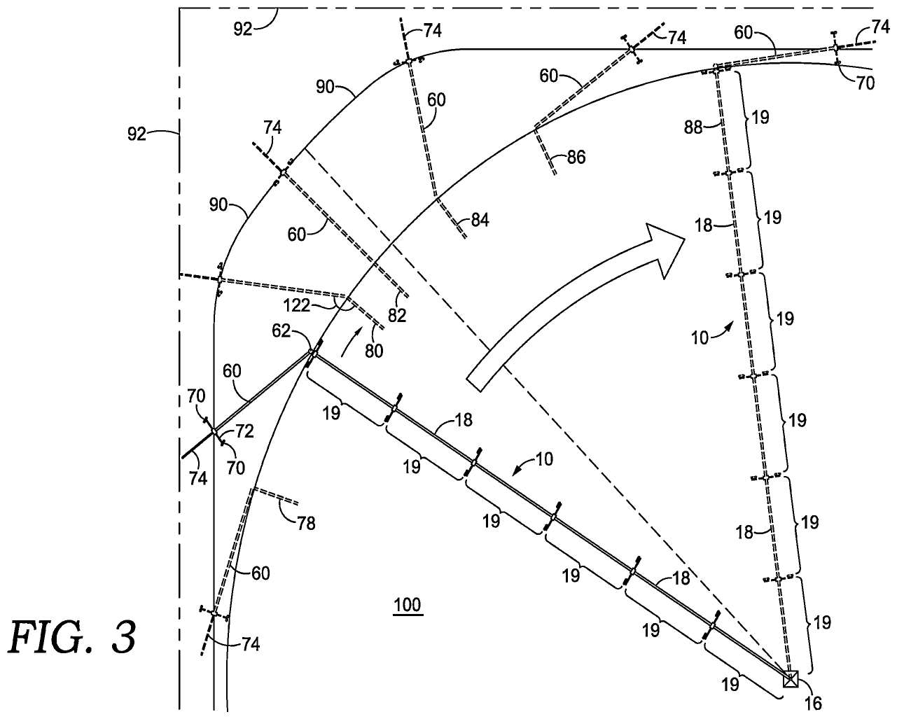

Referring now to FIG. 3, the components and operation of the ancillary irrigation span 60 as it transitions from a trailing configuration to a leading configuration and vice versa are illustrated. In FIG. 3, the primary irrigation system 10 is illustrated being comprised of a number of individual spans 19 connected together to form a longer primary irrigation system 10 than is illustrated in FIGS. 1 and 2. As the primary irrigation span turns about the central pivot point 16 at the proximal end of the primary irrigation system 10, the ancillary steering tower can pivot the ancillary irrigation span 60 out into a field corner either in a leading state (in front of the primary irrigation span) or in a trailing state (behind the primary irrigation span). In FIG. 3, the SAC 60 is illustrated in a trailing state in the lower left-hand portion of the field-of-interest 100, and the SAC 60 is illustrated transitioning into a leading state in the upper right-hand portion of the field-of-interest 100 as the primary pipeline 10 moves in a clockwise manner. As the primary irrigation system 10 moves in the clockwise manner, illustrated in FIG. 3, the ancillary irrigation span 60 is illustrated transitioning from a starting state 78 (illustrated in ghost) to state 80, to state 82 at which the ancillary irrigation span 60 is roughly parallel or in line with the primary irrigation system 10 and is directed into the corner of the field-of-interest 100. As the primary pipeline 10 continues movement around the path of travel 90, the ancillary irrigation span 60 is illustrated transitioning into a leading state to state 84, to state 86 and then to state 88 where the ancillary irrigation span 60 is roughly perpendicular to the primary pipeline 10 after the primary pipeline 10 has cleared the corner of the field-of-interest 100 illustrated inside boundary 92 (e.g., fenceline). As illustrated in FIG. 3, the ancillary irrigation span 60 may rotate at least 90 degrees to either side of the distal end of the primary irrigation system 10, but as should be appreciated, the ancillary irrigation span 60 may be configured to rotate more or less than 90 degrees as may be required for a given use.

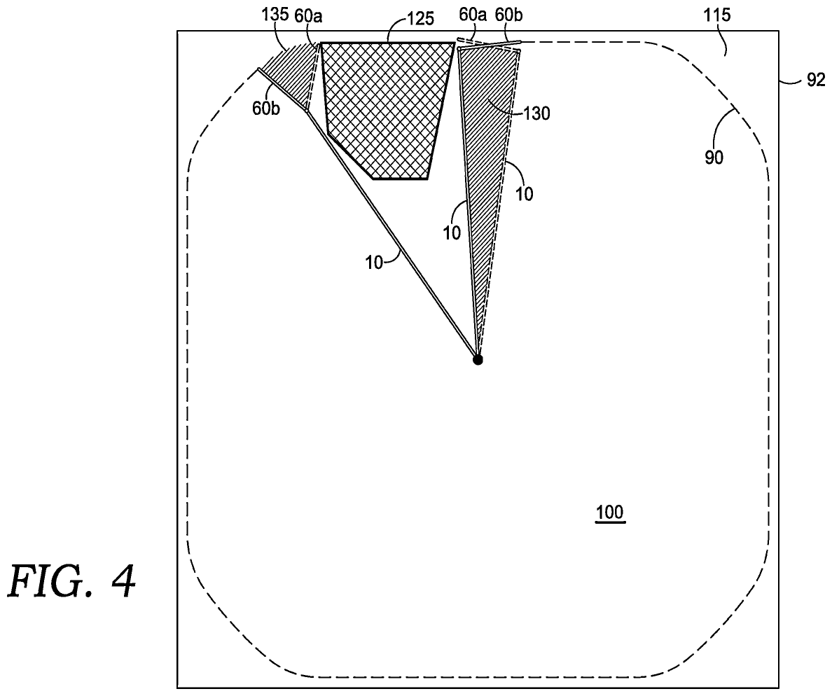

The transitional states illustrated in FIG. 3 are for purposes of illustrating movement of the ancillary irrigation span 60 from a trailing state to a leading state, but are not limiting of typical operation of the ancillary irrigation span 60. For example, when the primary irrigation system 10 is capable of moving a full 360 degrees without interruption by an obstacle in the field-of-interest 100, an ancillary irrigation span 60 configured to be leading may always maintain a leading orientation in front of the primary irrigation span throughout the entire path of travel in one direction, or the ancillary irrigation span 60 configured to be trailing may always maintain a trailing orientation behind the primary irrigation span when the primary irrigation span is running in the opposite direction. In this manner, the ancillary irrigation span 60 provides a controllable and moveable extension to the primary irrigation span, which can cover a substantial portion of each field corner or areas near or around obstacles in the field-of-interest. As described below with reference to FIG. 4, the ancillary irrigation span 60 may be automatically transitioned from a trailing to leading configuration or vice versa to allow the irrigation system comprised of the primary irrigation system 10 and the ancillary irrigation span 60 to irrigate the field-of-interest in areas about an obstacle in the field of interest.

Referring still to FIG. 3, the disclosed systems and methods utilize a path of travel 90 determined for the ancillary steering tower 72. It is noted that in FIG. 3, only a portion of the path of travel 90 is depicted. This is in no way meant to limit embodiments of the present disclosure. The area capable of being irrigated by the ancillary irrigation span 60 is highly variable due to the number of maneuvers that can be performed by the ancillary irrigation span 60. That is, during normal operations, the SAC 60 can extend and retract as well as travel at increased and decreased velocities relative to the primary irrigation system 10, even though it is coupled with the primary irrigation system 10 at the hinge point 62. The path of travel 90 for the ancillary steering tower 72 comprises a file that includes a plurality of polar coordinates that are referenced from the central pivot point 16. In some embodiments, the path of travel includes 3,600 polar coordinates for a full rotation of the irrigation system.

It should be noted that in the illustrated embodiment and the discussion described herein, the orientation of the ancillary steering tower 72 with respect to the pipeline 74 of the SAC 60 is fixed and the wheels 70 of the ancillary steering tower 72 rotate with respect to the ancillary steering tower 72. Consequently, the wheels 70 of the ancillary steering tower 72 do not follow in the same path nor do they follow along the path of travel 90, as described herein or illustrated. Instead, the path of travel 90 is the imaginary path along the ground above which the ancillary steering tower 72 travels. It is within the scope of embodiments of the present disclosure to have an ancillary steering tower where the orientation between the wheels of the ancillary steering tower and the ancillary steering tower itself is fixed (e.g., like it is on a tower under the principle span of the parent system) and the orientation of the ancillary steering tower with respect to the pipeline 74 of the ancillary irrigation span 60 is variable (i.e., where the ancillary steering tower rotates with respect to the ancillary irrigation span). In such an arrangement, the wheels of the ancillary tower may ride in a single path, thereby minimizing crop damage, and the single path could actually be along the path of travel.

In illustrative embodiments, to determine the path of travel 90 for the ancillary steering tower 72, the distance of the reference point (the center point in the illustrated embodiment) of the ancillary steering tower 72 from the central pivot point 16 and the angle 122 of the ancillary irrigation span 60 relative to the primary irrigation system 10 may be determined. To determine these two factors, the boundary 92 (i.e., physical borders) of the field-of-interest 100 is determined. It is noted that in FIG. 3, only a portion of the boundary 92 and of the field-of-interest 100 is illustrated. This is in no way meant to limit embodiments of the present disclosure.

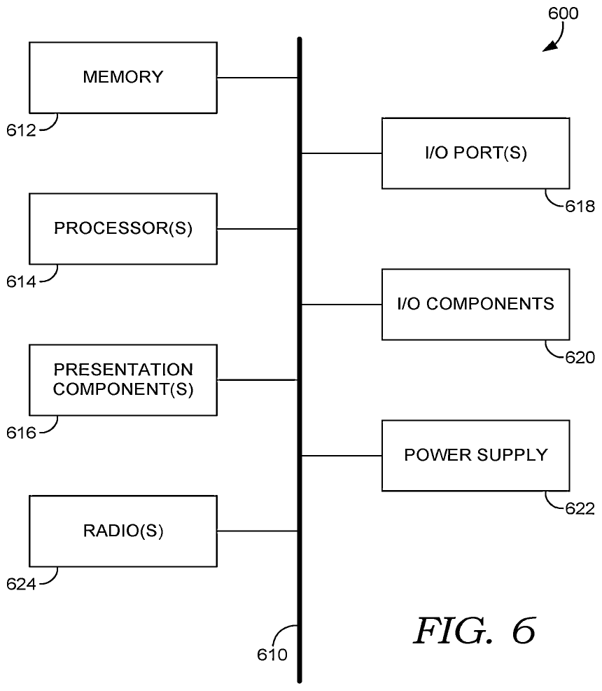

In some embodiments, the boundary 92 of the field-of-interest 100 may be determined by geospatial mapping. In some embodiments, geospatial mapping is accomplished through the use of global positioning systems (GPSs) with the output being a file containing coordinates. These coordinates define the boundary 92 of the field-of-interest 100. In some embodiments, a GPS sensor or other suitable geospatial mapping apparatus (not shown) is coupled with the ancillary steering tower 72. The sensor or other suitable apparatus may be communicatively coupled with one or more computing devices 600 (FIG. 6) (e.g., servers and/or databases) configured for receiving, interpreting, and storing sensed geospatial data and for controlling movement of the primary irrigation system 10 and the ancillary irrigation span 60.

It will be understood and appreciated by those having ordinary skill in the art that other methods of capturing the field-of-interest may be utilized. Reference to the illustrative embodiments herein is not meant to limit the scope of embodiments of the present disclosure in any way. Any number of field-of-interest-capturing variations, and any combination thereof, are contemplated to be within the scope of embodiments of the present disclosure.

With the boundary 92 known, the irrigation system is fitted to optimize the area within the mapped boundary that is capable of being irrigated by the primary irrigation system 10. As a result of this optimization process, an optimal location for the central pivot point 16 of the irrigation system is determined. The central pivot point 16 provides the point at which all spans 19 of the primary irrigation system 10, typical and non-typical, are attached through linking the spans 19 together. The spans 19 swivel as a single unit around the central pivot point 16. This causes the spans 19 to travel in a circular operation, representing a circle upon completion of a full operation. During the optimization process and determination of the location of the central pivot point 16, spans 19 are selected to fit within the boundary. The last span of the primary irrigation system 10 is the final span in the link of one or more typical spans comprising the primary irrigation system 10.

Utilizing the combination of the field-of-interest boundary 92 and the last span of the primary irrigation system 10 as constraints, an optimal ancillary irrigation span 60 is selected such that the ancillary irrigation span 60 is capable of irrigating as large an area outside the area covered by the primary irrigation system 10 as possible. The selected ancillary irrigation span 60 is coupled with the primary irrigation system 10 at the hinge point 62 located at a distal end of the last span to provide additional coverage in the corners due to the ability of the ancillary irrigation span 60 to extend and retract in and out of the field corners and/or around other obstacles through the use of the independently controlled ancillary steering tower 72.

With reference still to FIG. 3, the path of travel 90 of the ancillary steering tower 72 is determined by the maneuvers required to optimize coverage within the constraints and parameters of the field-of-interest boundary 92 and the last span 19. According to aspects of the present disclosure, the determination of the path of travel 90 is performed by the control system 600 illustrated in FIG. 6. According to one example aspect, the constraints and parameters considered in determining the path of travel 90 include physical constraints, transitions and folds information. Physical constraints may include length of the ancillary irrigation span 60 from the end tower 24 of the primary irrigation system 10 to the wheels 70 of the ancillary irrigation span 60, length of the ancillary irrigation span 60 from the end tower 24 of the primary irrigation span 10 to the end of the extension pipeline or boom 74, the perimeter of the covered ground where the SAC wheels can move across, and information associated with the maximum travel path clearance perimeter and fluid application coverage perimeter. In addition, information associated with the soil type and its characteristics may be considered.

Other parameters that may be considered in determining the path of travel 90 include ancillary irrigation span 60 transitions parameters. Examples of transition parameters include a consideration of whether the SAC 60 is in a leading configuration and is extending into a corner or in a trailing configuration and is collapsing out of a corner. According to another example transition parameter, a consideration is given to whether the SAC 60 is moving from a collapsed configuration in a trailing configuration to an extended configuration in a leading configuration or vice versa.

These maneuvers are recorded within a file maintained by a control system 600 responsible for controlling movement and use of the primary irrigation system 10 and SAC 60 as described herein. By way of example only, 3,600 polar coordinates correlating the central pivot point 16 to the location of a positioning system (not shown) may be stored at the control system 600 (FIG. 6) corresponding to the ancillary steering tower 72. In embodiments, the ancillary steering tower positioning system is coupled with the ancillary steering tower 72 itself.

The ancillary irrigation span 60 may be transitioned from a leading configuration to a trailing configuration at a corner of a field, in some aspects. When entering a corner where the ancillary irrigation span 60 will transition, the primary irrigation system 10 may continue to rotate about the center pivot point 16 until a transition point is reached (e.g., a center point of the corner). Once the transition point is reached, the primary irrigation system 10 may halt until the ancillary irrigation span 60 rotates from the leading configuration to the trailing configuration (or vice versa). After the ancillary irrigation span 60 transitions, the primary irrigation system 10 may resume rotation about the center pivot point 16. In other aspects, the primary irrigation system 10 does not stop rotating at a rotation point, but slows its rotation speed in a rotation zone to allow the ancillary irrigation span 60 to speed past the end of the primary irrigation system 10 and transition between the leading configuration and the trailing configuration. In these aspects, once the ancillary irrigation span 60 has transitioned, the primary irrigation system 10 may resume its normal rotation speed about the center pivot point 16.

In either of these types transition movements (e.g., stop and flip, slow and flip), an unbalanced amount of irrigation fluid may be delivered to the field of interest 100. For example, if the irrigation fluid continues to flow during the transition movement, then the primary irrigation system 10 may over water at the transition point or through the transition zone. On the other hand, if the irrigation fluid ceases to flow during the transition movement, then the ancillary irrigation span 60 may under water the corner of the field where the transition occurs.

One way to control the water application would be to independently control dispensing of irrigation fluid from each of the primary irrigation system 10 and the ancillary irrigation span 60. For example, at the transition point the primary irrigation system 10 may cease dispensing irrigation fluid until rotation resumes. In other aspects, at the transition zone the primary irrigation span 10 may decrease dispensing of irrigation fluid until normal rotation speed resumes. During either of these changes to dispensing of irrigation fluid from the primary irrigation system 10, dispensing from the ancillary irrigation span 60 may continue as normal.

Independent control of the water application may be cost prohibitive and/or introduce additional maintenance needs to the system. Thus, in alternative aspects, the primary irrigation system 10 may rapidly traverse the transition zone forward, then backward, while the ancillary irrigation span 60 makes the transition, before resuming rotation in the original direction with the ancillary irrigation span 60 in the transitioned state. For example, when approaching a transition zone the primary irrigation system 10 may increase to high speed to quickly pass over the transition zone before the ancillary irrigation span 60 transitions, then quickly reverse course back over the transition zone while the ancillary irrigation span 60 transitions, then reverse course again to the original direction of rotation after the transition of the ancillary irrigation span 60 has occurred. In this way the ancillary irrigation span 60 delivers the anticipated amount of irrigation fluid to the corner while over watering of the primary portion of the field of interest is minimized or eliminated.

Referring now to FIG. 4, operation of the ancillary irrigation span 60 transition between leading and trailing configuration (and vice versa) to allow for paths of travel that are less than 360 degrees or to avoid under-irrigated or non-irrigated space in the field-of-interest 100 is illustrated. As discussed above, in some cases, obstacles or the field shape impact operation of the primary irrigation system 10 and the ancillary irrigation span 60. Such obstacles may include any number of items, for example, trees, rocks, ponds, buildings, and the like. In addition, such obstacles may be present at different locations from the proximal end of the primary irrigation span to the distal end of the primary irrigation system 10 or in an area that will be contacted by an extended ancillary irrigation span 60. That is, such obstacles or field shape may prevent the primary irrigation system from operating at 360 degrees of rotation. When full rotation is unachievable, the irrigation system 10 along with the ancillary irrigation span 60 may operate as a partial system or rotate less than 360 degrees. In most partial system cases, adding the ancillary irrigation span 60 adds critical irrigation space (e.g., acres of space) to the coverage area. However, the ancillary irrigation span hinge configuration may prevent the primary irrigation system 10 from traveling the maximum possible degrees since the ancillary irrigation span 60 may require parking space at the start or stop angle, for example, when the primary irrigation system 10 must stop at an obstacle before reversing direction away from the obstacle. As such, considerations are given to know whether a leading or trailing ancillary irrigation span 60 configuration provides the best coverage based on the field-of-interest and any obstacles or field shapes.

For example, as illustrated in the example field-of-interest 100 and obstacle 125 in FIG. 4, if the ancillary irrigation span 60a is collapsed 90 degrees to a leading configuration to the ancillary irrigation span tower 24 at the distal end of the primary irrigation system 10a and the ancillary irrigation span 60a abuts an obstacle 125 or field edge, the primary irrigation system is offset from the obstacle 125 by the length of the ancillary irrigation span 60a, creating a wedge 130 that is not covered by the primary irrigation system 10a. According to aspects of the present disclosure, when the path of travel 90 is planned for the ancillary irrigation span 60a based on the constraints and parameters for the field-of-interest 100 as described above as it moves counter clockwise around the path of travel 90 toward the obstacle, the ancillary irrigation span 60a automatically transitions to a trailing configuration 60b at one of the corners of the field to allow the primary irrigation system 10 to move closer to the obstacle 125. Thus, the wedge 130 will receive irrigation because the transitioned SAC allows the primary irrigation span 10 to stop or park closer to the obstacle 125. That is, transitioning the ancillary irrigation span 60 to a trailing configuration according to this example, prevents the ancillary irrigation span 60 from blocking access of the primary irrigation system 10 to the space illustrated as a wedge 130.

For another example, on the other side of the obstacle 125, if the ancillary irrigation span 60b is in a trailing configuration as the primary irrigation system 10b approaches the obstacle 125, a wedge 135 is created that is not covered. According to aspects of the present disclosure, when the path of travel 90 is planned for the ancillary irrigation span 60 based on the constraints and parameters for the field-of-interest 100 as described above as it moves clockwise around the path of travel 90 toward the obstacle, the ancillary irrigation span 60b transitions from a trailing configuration to a leading configuration to allow the ancillary irrigation span 60a to move toward the obstacle 125. Thus, the wedge 135 will receive irrigation because the transitioned ancillary irrigation span 60a can move toward the obstacle 125.

For another example, if an obstacle 125 is positioned closer to the proximal end of the primary irrigation system 10 below the hinged intersection of the primary irrigation system 10 the controller 600 may direct the ancillary irrigation span 60 to transition to a leading configuration as the irrigation system or machine (primary irrigation span and ancillary pipeline span (SAC)) approaches the obstacle. By transitioning to a leading configuration, the SAC 60 may rotate above a portion of the obstacle 125 to partially envelope the obstacle 125 to provide irrigation above the obstacle 125 that would otherwise not be irrigated if the ancillary irrigation span 60 were in a trailing configuration as the primary irrigation span approaches and stops at the obstacle 125. As should be appreciated, when the primary irrigation system reverses course and ultimately approaches the obstacle from the other side, the ancillary irrigation span 60 may be transitioned to a leading configuration running in the opposite direction so that the ancillary irrigation span 60 will rotate above the obstacle from the other side to provide irrigation onto the coverage area above the obstacle on the other side of the obstacle 125.

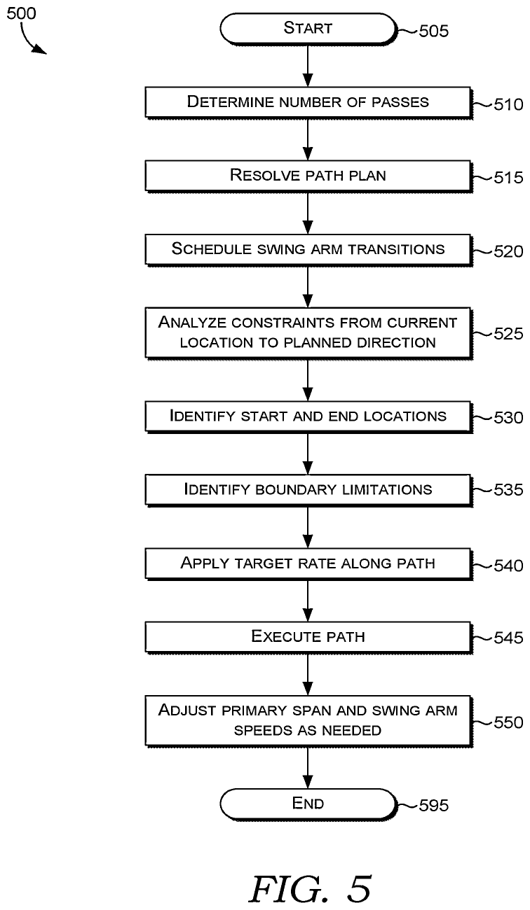

FIG. 5 depicts a flow diagram illustrating a method of irrigating an irrigation coverage area of a field-of-interest in accordance with aspects of the present disclosure. The method begins at start operation 505 and proceeds to operation 510. At operation 510, the controller 600 (FIG. 6) determines if one or multiple passes are required for any section of the covered area (e.g., field-of-interest 100) to be irrigated as determined by user requirements or one or more constraints or parameters described above. At operation 515, the controller 600 determines a path of travel 90 for the planned irrigation.

At operation 520, transitions from leading to trailing or vice versa are scheduled in specific areas as described above with respect to FIG. 4. For example, if an obstacle 125 requires a transition of the ancillary irrigation span 60 from a leading to trailing configuration or vice versa to ensure irrigation is optimized, then ancillary irrigation span 60 transitions are scheduled. At operation 525, the controller 600 analyzes the various constraints and parameters described herein for moving the primary irrigation system 10 from a current location in the planned direction.

At operation 530, the controller 600 identifies start and end locations at which the primary irrigation system 10 will become constrained based on the reviewed and analyzed constraints and parameters for the field-of-interest 100. At operation 535, boundary limitations are determined for the field-of-interest 100. For example, if the boundary for the field-of-interest 100 force the path of travel 90 to be modified which will correspondingly cause a need for ancillary irrigation span 60 to transition, the boundary limitations determination may require further adjustment to ancillary irrigation span 60 transitions.

At operation 540, the controller 600 then applies the target fluid application rate along that specified path of travel 90 to determine the instantaneous rate of speed at each point. That is, if based on the various constraints and parameters for the field-of-interest 100 require the system (primary irrigation system 10 and ancillary irrigation span 60) to move faster in some areas and slower in other areas in order to achieve appropriate irrigation across the field-of-interest 100, then rates of speed at various areas along the path of travel 90 are determined.

At operation 545, the path of travel 90 is executed and movement of the primary irrigation span 10 and ancillary irrigation span 60 proceeds. At operation 550, if the controller 600 determines that the combined primary irrigation span 10 and ancillary irrigation span 60 or either component individually needs to speed up or slow down to achieve required irrigation, adjustments to the speeds of either or both the primary irrigation span 10 and ancillary irrigation span 60 are made as irrigation is performed. At operation 545, the controller 600 may also adjust fluid flow rates from the primary irrigation system 10 and the ancillary irrigation span 60 as part of adjusting the speed of the irrigation system 10 and the ancillary irrigation span 60 and as part of transitioning the ancillary irrigation span 60 to different states as illustrated and described above with reference to FIG. 3. For example, if the ancillary irrigation span 60 is transitioned to a position perpendicular to the primary irrigation system 10, there would be little to no need for fluid to be released from the ancillary irrigation span 60, and thus, the controller 600 may direct that the flow rate from the ancillary irrigation span 60 in such a situation may stop or may be greatly limited.

The method ends at operation 595.

FIG. 6 is a simplified block diagram of a computing system or controller 600 with which examples of the present disclosure may be practiced. As described above, movement of the components of the primary irrigation span and ancillary irrigation span 60 (or swing arm corner span (SAC)) may be planned and executed by the computing system or controller 600. Aspects of the present disclosure may be described in the general context of computer code or machine-useable instructions, including computer-executable instructions, such as program modules, being executed by a computer or other machine, such as a personal data assistant or other handheld device. Generally, program modules including routines, programs, objects, components, data structures, etc., refer to code that perform particular tasks or implement particular abstract data types. Aspects of the present disclosure may be practiced in a variety of system configurations, including hand-held devices, consumer electronics, general-purpose computers, more specialty computing devices, etc. Aspects of the present disclosure may also be practiced in distributed computing environments where tasks are performed by remote-processing devices that are linked through a communications network.

With reference to FIG. 6, the computing device 600 includes a bus 610 that directly or indirectly couples the following devices: a memory 612, one or more processor(s) 614, one or more presentation component(s) 616, input/output (I/O) port(s) 618, input/output components 620, an illustrative power supply 622, and radio(s) 624. The bus 610 represents what may be one or more busses (such as an address bus, a data bus, or a combination thereof). Although various blocks of FIG. 6 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art and reiterates that the diagram of FIG. 6 is merely illustrative of an exemplary computing device that can be used in connection with one or more embodiments of the present disclosure. Distinction is not made between such categories as “workstation,” “server,” “laptop,” “hand-held device,” etc., as all are contemplated within the scope of FIG. 6 and with reference to the term “computing device or controller.”

The computing device 600 typically includes a variety of computer-readable media. The computer-readable media can be any available media that can be accessed by the computing device 600 and includes both volatile and nonvolatile media, and removable and non-removable media. By way of non-limiting example, the computer-readable media may comprise computer storage media and communication media. The computer storage media includes both volatile and nonvolatile, removable, and non-removable media implemented in any method or technology for storage of information, such as computer-readable instructions, data structures, program modules or other data. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile disks (DVDs) or other optical disk storage, magnetic cassettes, magnetic tape, magnetic disk storage or other magnetic storage devices, or any other medium which can be used to store the desired information and which can be accessed by the computing device 600. The computer storage media does not comprise signals per se. The communication media typically embodies computer-readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information in the signal. By way of non-limiting example, the communication media includes wired media, such as a wired network or direct-wired connection, and wireless media, such as acoustic, RF, infrared and other wireless media. Combinations of any of the above should also be included within the scope of computer-readable media.

The memory 612 includes computer-storage media in the form of volatile and/or nonvolatile memory. The memory 612 may be removable, non-removable, or a combination thereof. Exemplary hardware devices include solid-state memory, hard drives, optical-disc drives, etc. The computing device 600 includes one or more processor(s) 614 that read data from various entities such as the memory 612 or the I/O components 620. The presentation component(s) 616 present data indications to the user or other device. Exemplary presentation component(s) 616 include a display device, a speaker, a printing component, a vibrating component, etc.

The I/O port(s) 618 allow the computing device 600 to be logically coupled to other devices including the I/O components 620, some of which may be built in. Illustrative components include a microphone, a joystick, a game pad, a satellite dish, a scanner, a printer, a wireless device, etc. The I/O components 620 may provide a natural user interface (NUI) that processes air gestures, voice, or other physiological inputs generated by the user. In some instances, inputs may be transmitted to an appropriate network element for further processing. The NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be equipped with depth cameras, such as stereoscopic camera systems, infrared camera systems, RGB camera systems, touchscreen technology, and combinations of these, for gesture detection and recognition. Additionally, the computing device 600 may be equipped with accelerometers or gyroscopes that enable detection of motion. An output of the accelerometers or the gyroscopes may be provided to the display of the computing device 600 to render immersive augmented reality or virtual reality.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

What is claimed:

1. An irrigation machine comprising:
a primary irrigation system operative to rotate for irrigating an irrigation coverage area; and
an ancillary irrigation span hingedly connected to a distal end of the primary irrigation system, the ancillary irrigation span being operative to automatically transition from a first configuration trailing movement of the distal end of the primary irrigation system to a second configuration leading movement of the distal end of the primary irrigation system.

2. The irrigation machine of claim 1, wherein the ancillary irrigation span is further operative to transition from an orientation in line with the primary irrigation system to the first configuration trailing movement of the distal end of the primary irrigation system, the first configuration including rotating the ancillary irrigation span about the hinged connection to the trailing configuration such that the ancillary irrigation span is oriented up to a 90 degree angle behind the primary irrigation system.

3. The irrigation machine of claim 1, wherein the ancillary irrigation span is further operative to transition from an orientation in line with the primary irrigation system to the second configuration leading movement of the distal end of the primary irrigation system, the second configuration including rotating the ancillary irrigation span about the hinged connection to the leading configuration such that the ancillary irrigation span is oriented up to a 90 degree angle in front of the primary irrigation system.

4. The irrigation machine of claim 1, wherein the ancillary irrigation span is operative to automatically transition to the first configuration away from a path of travel of the primary irrigation system to allow the irrigation machine to move towards an obstacle in the irrigation coverage area.

5. The irrigation machine of claim 4, wherein the ancillary irrigation span is operative to automatically transition to the first configuration away from the path of travel of the primary irrigation system to irrigate a portion of the irrigation coverage area adjacent to the obstacle.

6. The irrigation machine of claim 1, wherein the ancillary irrigation span is operative to automatically transition to the second configuration ahead of a path of travel of the primary irrigation system to move to the ancillary irrigation span around a portion of an obstacle in the irrigation coverage area.

7. The irrigation machine of claim 6, wherein the ancillary irrigation span is operative to automatically transition to the second configuration ahead of the path of travel of the primary irrigation system to irrigate a portion of the irrigation coverage around the obstacle.

8. The irrigation machine of claim 7, wherein the ancillary irrigation span is operative to automatically transition to the second configuration ahead of the path of travel of the primary irrigation system to at least partially envelop the obstacle.

9. The irrigation machine of claim 1, wherein the ancillary irrigation span is operative to adjust an irrigation flow rate from the ancillary irrigation span in response to a transition of the ancillary irrigation span away from a distal end of the primary irrigation system.

10. The irrigation machine of claim 9, wherein the ancillary irrigation span is operative to adjust a rate of travel of the ancillary irrigation span relative to the primary irrigation system along a path of travel of the irrigation machine to adjust the flow rate from the ancillary irrigation span in response to a transition of the ancillary irrigation span away from a distal end of the primary irrigation system.

11. A method of irrigating an irrigation coverage area; comprising:
receiving, by an irrigation system, an instruction to irrigate the irrigation coverage area, the irrigation system including a primary irrigation system operative to rotate about a pivot point and an ancillary irrigation span hingedly connected to a distal end of the primary irrigation system, the ancillary irrigation span being operative to automatically transition from a first configuration trailing movement of the distal end of the primary irrigation system to a second configuration leading movement of the distal end of the primary irrigation system;
determining that an obstacle is present in the irrigation coverage area that prevents a 360 degree rotation of the irrigation system along a path of travel around the irrigation coverage area;
rotating the irrigation system along the path of travel while irrigating the irrigation coverage area; and,
as the irrigation system moves toward the obstacle, automatically transitioning the ancillary irrigation span to allow the irrigation system to approach the obstacle such that a portion of the irrigation coverage area adjacent to the obstacle receives irrigation.

12. The method of claim 11, wherein automatically transitioning the ancillary irrigation span to allow the irrigation system to approach the obstacle includes transitioning the ancillary irrigation span to the first configuration to prevent the ancillary irrigation span from blocking access of the irrigation system to the portion of the irrigation coverage area adjacent to the obstacle.

13. The method of claim 11, wherein automatically transitioning the ancillary irrigation span to allow the irrigation system to approach the obstacle includes transitioning the ancillary irrigation span to the second configuration to allow the ancillary irrigation span to rotate around a portion of the obstacle to allow irrigation of a portion of the irrigation coverage area above the obstacle.

14. The method of claim 11, prior to rotating the irrigation system along the path of travel while irrigating the irrigation coverage area, further comprising scheduling a transition of the ancillary irrigation span based on determining that an obstacle is present in the irrigation coverage area that prevents a 360 degree rotation of the irrigation system along a path of travel around the irrigation coverage area.

15. The method of claim 14, further comprising determining and applying a rate of travel of the irrigation system along the path of travel;

16. The method of claim 15, further comprising:
prior to determining and applying a rate of travel of the irrigation system along the path of travel, further comprising determining whether one or more constraints associated with the irrigation coverage area requires a given rate of travel of the irrigation system along the path of travel.

17. The method of claim 16, further comprising:
during rotating the irrigation system along the path of travel while irrigating the irrigation coverage area, adjusting the rate of travel of the irrigation system along the path of travel based on determining that the one or more constraints associated with the irrigation coverage area requires one or more different rates of travel of the irrigation system along the path of travel.

18. The method of claim 17, wherein adjusting the rate of travel of the irrigation system along the path of travel includes adjusting a rate of travel of the primary irrigation system independently from adjusting a rate of travel of the ancillary irrigation span.

19. An irrigation system, comprising:
a primary irrigation system operative to rotate for irrigating an irrigation coverage area;
an ancillary irrigation span hingedly connected to a distal end of the primary irrigation system, the ancillary irrigation span being operative to:
automatically transition from a first configuration trailing movement of the distal end of the primary irrigation system to a second configuration leading movement of the distal end of the primary irrigation system;
automatically transition from a second configuration leading movement of the distal end of the primary irrigation system to a first configuration trailing movement of the distal end of the primary irrigation system;
automatically transition to the first configuration away from a path of travel of the primary irrigation system to allow the primary irrigation system to move adjacent to an obstacle in the irrigation coverage area; and
automatically transition to the second configuration ahead of a path of travel of the primary irrigation system to move to the ancillary irrigation span around a portion of an obstacle in the irrigation coverage area.

20. The irrigation system of claim 19, further comprising a controller operative to:
schedule a transition of the ancillary irrigation span based on determining that an obstacle is present in the irrigation coverage area that prevents a 360 degree rotation of the irrigation system along a path of travel around the irrigation coverage area;
determine and apply a rate of travel of the irrigation system along the path of travel;
determine whether one or more constraints associated with the irrigation coverage area requires a given rate of travel of the irrigation system along the path of travel; and
adjust the rate of travel of the irrigation system, including the rate of travel of either of the primary irrigation system or the ancillary irrigation span, along the path of travel based on determining that the one or more constraints associated with the irrigation coverage area requires one or more different rates of travel of the irrigation system along the path of travel.
